(19) United States
(12) Patent Application Publication
(10) Pub. No.: US 2023/0413125 A1
(43) Pub. Date: Dec. 21, 2023

(54) TECHNIQUES FOR TRANSMISSION CONFIGURATION INDICATOR STATE SWITCHING FOR HANDOVER PROCEDURES

(71) Applicant: QUALCOMM Incorporated, San Diego, CA (US)

(72) Inventors: Chinmay Shankar VAZE, San Diego, CA (US); Chun-Hao HSU, San Jose, CA (US); Priyanka YENIGALLA, Erie, CO (US); Vishnu Namboodiri KARAKKAD KESAVAN NAMBOODIRI, Hyderabad (IN); Zhanyi LIU, Beijing (CN); Jing LI, Shanghai (CN); Rashmi Ranjan MOHANTY, San Diego, CA (US)

(21) Appl. No.: 18/248,645

(22) PCT Filed: Dec. 14, 2020
(86) PCT No.: PCT/CN2020/136039

§ 371 Date: Apr. 11, 2023

(51) Int. Cl. H04W 36/00

(52) U.S. Cl. CPC H04W 36/0022; H04W 36/0064

(57) ABSTRACT

Methods, systems, and devices for wireless communications are described. Generally, a user equipment (UE) may communicate with a first network device in a first communications system (e.g., a non-standalone (NSA) system) prior to initiating a handover to a second communications system (e.g., a standalone (SA) system). In some examples, the UE may receive a first tracking reference signal (TRS) from the first network device using a first transmission configuration indicator (TCI) state. The first network device may include an indication of the first TCI state in a control message. The UE may initiate a handover from the first network device to the second network device. Subsequent to the handover, the UE may receive a second TRS from the second network device. The UE may receive the second TRS using the first TCI state based on determining that one or more antenna port configuration conditions are satisfied.

### CROSS REFERENCE

The present Application is a 371 national stage filing of International PCT Application No. PCT/CN2020/136039 by VAZE et al. entitled “TECHNIQUES FOR TRANSMISSION CONFIGURATION INDICATOR STATE SWITCHING FOR HANDOVER PROCEDURES,” filed Dec. 14, 2020, which is assigned to the assignee hereof, and which is expressly incorporated by reference in its entirety herein.

### FIELD OF DISCLOSURE

The following relates to wireless communications, including techniques for transmission configuration indicator state switching for handover procedures.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE). In some examples, UEs may initiate handovers from one system or subsystem to another.

### SUMMARY

The described techniques relate to improved methods, systems, devices, and apparatuses that support techniques for transmission configuration indicator state switching for handover procedures. Generally, a user equipment (UE) may communicate with a first network device in a first communications system (e.g., a non-standalone (NSA) system) prior to initiating a handover to a second communications system (e.g., a standalone (SA) system). In some examples, the UE may receive a first tracking reference signal (TRS) from the first network device using a first transmission configuration indicator (TCI) state. The first network device may include an indication of the first TCI state in a control message. The UE may initiate a handover from the first network device to the second network device. Subsequent to the handover, the UE may receive a second TRS from the second network device. The UE may receive the second TRS using the first TCI state based on determining that one or more antenna port configuration conditions are satisfied. For example, the UE may determine that implicit down-selection has failed, that no quasi-co-location (QCL) relationship exists between synchronization signal blocks (SSBs) and TRSs, that no control message indicating an updated TCI state is to be transmitted by the second network device, or any combination thereof.

A method for wireless communications at a user equipment (UE) is described. The method may include receiving, from a first network device in a first cell, a first tracking reference signal using a first transmission configuration indicator state of a set of transmission configuration indicator states, initiating a handover from the first network device to a second network device, and receiving, from the second network device, a second tracking reference signal using the first transmission configuration indicator state, where using the first transmission configuration indicator state is based on one or more antenna port configuration conditions being satisfied.

An apparatus for wireless communications at a UE is described. The apparatus may include a processor, memory in electronic communication with the processor, and instructions stored in the memory. The instructions may be executable by the processor to cause the apparatus to receive, from a first network device in a first cell, a first tracking reference signal using a first transmission configuration indicator state of a set of transmission configuration indicator states, initiate a handover from the first network device to a second network device, and receive, from the second network device, a second tracking reference signal using the first transmission configuration indicator state, where using the first transmission configuration indicator state is based on one or more antenna port configuration conditions being satisfied.

Another apparatus for wireless communications at a UE is described. The apparatus may include means for receiving, from a first network device in a first cell, a first tracking reference signal using a first transmission configuration indicator state of a set of transmission configuration indicator states, means for initiating a handover from the first network device to a second network device, and means for receiving, from the second network device, a second tracking reference signal using the first transmission configuration indicator state, where using the first transmission configuration indicator state is based on one or more antenna port configuration conditions being satisfied.

A non-transitory computer-readable medium storing code for wireless communications at a UE is described. The code may include instructions executable by a processor to receive, from a first network device in a first cell, a first tracking reference signal using a first transmission configuration indicator state of a set of transmission configuration indicator states, initiate a handover from the first network device to a second network device, and receive, from the second network device, a second tracking reference signal using the first transmission configuration indicator state, where using the first transmission configuration indicator state is based on one or more antenna port configuration conditions being satisfied.

Some examples of the method, apparatuses, and non-transitory computer-readable medium described herein may further include operations, features, means, or instructions for monitoring, after initiating the handover, for a control message including an indication of a second transmission configuration indicator state and failing to receive the control message based on the monitoring.

Some examples of the method, apparatuses, and non-transitory computer-readable medium described herein may further include operations, features, means, or instructions for determining that the first transmission configuration indicator state may be one of the set of transmission configuration indicator states.

Some examples of the method, apparatuses, and non-transitory computer-readable medium described herein may further include operations, features, means, or instructions for determining that a quasi co-location relationship does not exist between one or more synchronization signals and at least one of the first tracking reference signal or the second tracking reference signal.

Some examples of the method, apparatuses, and non-transitory computer-readable medium described herein may further include operations, features, means, or instructions for processing the second tracking reference signal using the first transmission configuration indicator state; and receiving control signaling, data signaling, or both, based on the processed tracking reference signal.

In some examples of the method, apparatuses, and non-transitory computer-readable medium described herein, initiating the handover may include operations, features, means, or instructions for initiating a same-cell handover.

In some examples of the method, apparatuses, and non-transitory computer-readable medium described herein, initiating the handover may include operations, features, means, or instructions for initiating a handover from a non-standalone system to a stand-alone system.

In some examples of the method, apparatuses, and non-transitory computer-readable medium described herein, the first network device includes a base station, a repeater, a radio head, or any combination thereof, associated with a high speed train network deployment.

Some examples of the method, apparatuses, and non-transitory computer-readable medium described herein may further include operations, features, means, or instructions for receiving, from the first network device prior to initiating the handover, a control message including an indication of the first transmission configuration indicator state, where receiving the first tracking reference signal using the first transmission configuration indicator state may be based on receiving the control message.

### BRIEF DESCRIPTION OF THE DRAWINGS

FIG. 1 illustrates an example of a wireless communications system that supports techniques for transmission configuration indicator state switching for handover procedures in accordance with aspects of the present disclosure.

FIG. 2 illustrates an example of a wireless communications system that supports techniques for transmission configuration indicator state switching for handover procedures in accordance with aspects of the present disclosure.

FIG. 3 illustrates an example of a process flow that supports techniques for transmission configuration indicator state switching for handover procedures in accordance with aspects of the present disclosure.

FIGS. 4 and 5 show block diagrams of devices that support techniques for transmission configuration indicator state switching for handover procedures in accordance with aspects of the present disclosure.

FIG. 6 shows a block diagram of a communications manager that supports techniques for transmission configuration indicator state switching for handover procedures in accordance with aspects of the present disclosure.

FIG. 7 shows a diagram of a system including a device that supports techniques for transmission configuration indicator state switching for handover procedures in accordance with aspects of the present disclosure.

FIGS. 8 through 11 show flowcharts illustrating methods that support techniques for transmission configuration indicator state switching for handover procedures in accordance with aspects of the present disclosure.

### DETAILED DESCRIPTION

In some cases, wireless communications systems may support various deployments and systems. For example, a user equipment (UE) in some communications systems may initiate a handover from a first communication system (e.g., a non-standalone (NSA) system such as a high speed train (HST) deployment) to a second communication system (e.g., a standalone (SA) system). Transitioning from one communication system to another communication system may introduce processing issues at the UE as the UE may rely on information specific to one communication system for processing control and data signaling in the other communication system.

In some cases, the UE may rely on one or more reference signals (e.g., tracking reference signals (TRSs)) to establish or maintain communication with network devices. In such a case, the TRSs may be quasi co-located (QCLed) with a physical downlink control channel (PDCCH), a physical downlink shared channel (PDSCH), a demodulation reference signal (DMRS), or any combination thereof. Thus, the UE may rely on the TRSs to receive and successfully process downlink information. A first network device in the first communication system may transmit control messages (e.g., a media access control (MAC) control element (CE)) indicating one or more transmission control information (TCI) states corresponding to the TRSs for the UE to use to receive and process each TRS. For example, a UE may receive an indication of a first TCI state to use to receive and process a first TRS, an indication of a second TCI state to use to receive and process a second TRS, and so forth. As such, the UE may receive the first TRS, process the first TRS, and receive one or more of PDCCH, PDSCH, DMRS corresponding to the first TRS by identifying the correct TCI state for receiving the first TRS.

In some cases, the first communication system may support the transmission of control messages explicitly indicating TCI states, but the second communication system may not support such signaling. So, when the UE initiates a handover procedure from the first communication system to the second communication system, the UE may expect to receive a control message indicating a TCI state for receiving subsequent TRSs, but may not receive such a control message. Thus, the UE may not be able to receive and process TRSs post-handover. This may result in the UE being unable to process PDCCH, PDSCH, DMRS, or the like. Thus, the UE may experience an increased BLER, decreased signal throughput, and potentially signal failure after such a handover.

In some examples, a UE may undergo a handover procedure from a first communication system (e.g., an NSA system such as an HST network) to a second communication system (e.g., an SA system). In some cases, prior to the handover, the UE may receive a control message (e.g., a MAC CE) indicating a first TCI state. Subsequently, the UE may initiate the handover from the first communication system to the second communication system. In some cases, the handover may be referred to as a same-cell handover. The UE may transfer a connection from a first base station (associated with the first communications system) to a second base station (associated with the second communications system).

Upon performing the handover, the UE may determine a TCI state for receiving subsequent TRSs based on determining whether a number of antenna port configuration conditions are satisfied. For example, the UE may determine that the one or more antenna port configuration conditions are satisfied by monitoring for a MAC-CE including an indication of a TCI state and failing to receive the MAC-CE. In some examples, the UE may determine that the one or more antenna port configuration conditions are satisfied by determining that multiple TCI states are configured (e.g., implicit down-selection of a TCI state fails). In some examples, the UE may determine that the one or more antenna port configuration conditions are satisfied if the UE determines the absence of a QCL relationship between synchronization signal blocks (SSBs) and TRSs. Based on determining that one or more antenna port configuration conditions are satisfied, the UE may identify the most recent TCI state explicitly indicated prior to the handover, and may use the identified TCI state to receive and process subsequent TRSs post-handover. This may allow the UE to successfully process control signaling, data signaling, DMRSs, or the like, resulting in continued connection to the base station and reduced signal latency.

Aspects of the disclosure may be implemented to realize one or more advantages. For example, performing handover procedures as described herein may result in decreased BLER, decreased likelihood of failed connections, improved communications, improved system efficiency, and improved user experience. Additionally, use of described techniques, including only implementing some techniques if one or more conditions are satisfied, may result in efficiently implementing described techniques only under the circumstances in which they will provide the most benefit to a wireless communications system.

Aspects of the disclosure are initially described in the context of wireless communications systems. Aspects of the disclosure are further illustrated by and described with reference to wireless communications systems and process flows. Aspects of the disclosure are further illustrated by and described with reference to apparatus diagrams, system diagrams, and flowcharts that relate to techniques for transmission configuration indicator state switching for handover procedures.

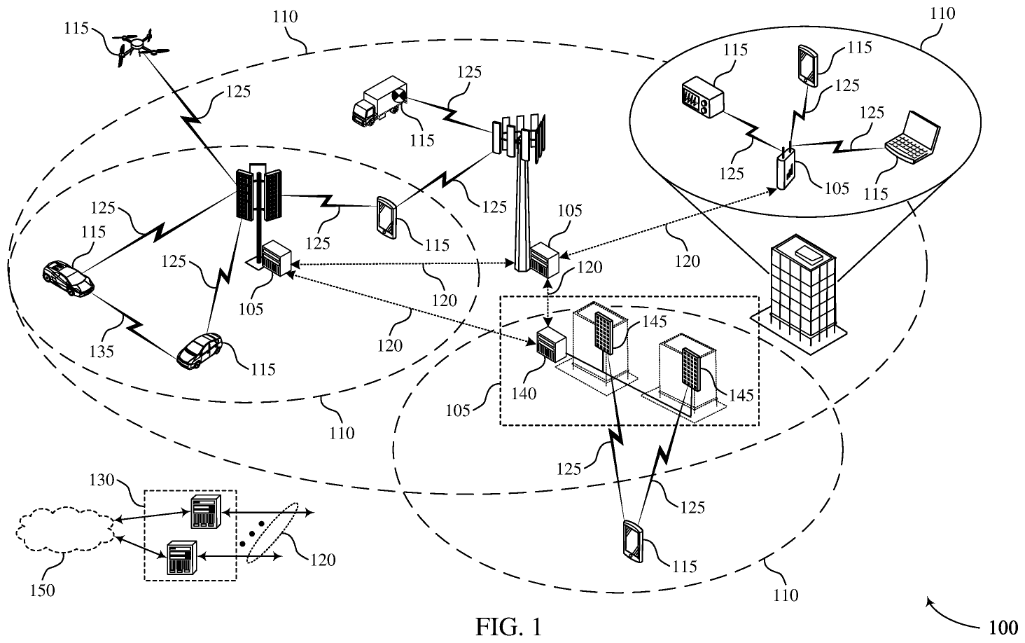

FIG. 1 illustrates an example of a wireless communications system 100 that supports techniques for transmission configuration indicator state switching for handover procedures in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ ·N_{f} seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Generally, a UE 115 may communicate with a first network device (e.g., a base station 105) in a first communications system (e.g., a non-standalone (NSA) system) prior to initiating a handover to a second communications system (e.g., a standalone (SA) system). In some examples, the UE 115 may receive a first tracking reference signal (TRS) from the first network device using a first TCI state. The first network device may include an indication of the first TCI state in a control message. The UE 115 may initiate a handover from the first network device to the second network device. Subsequent to the handover, the UE 115 may receive a second TRS from the second network device. The UE 115 may receive the second TRS using the first TCI state based on determining that one or more antenna port configuration conditions are satisfied.

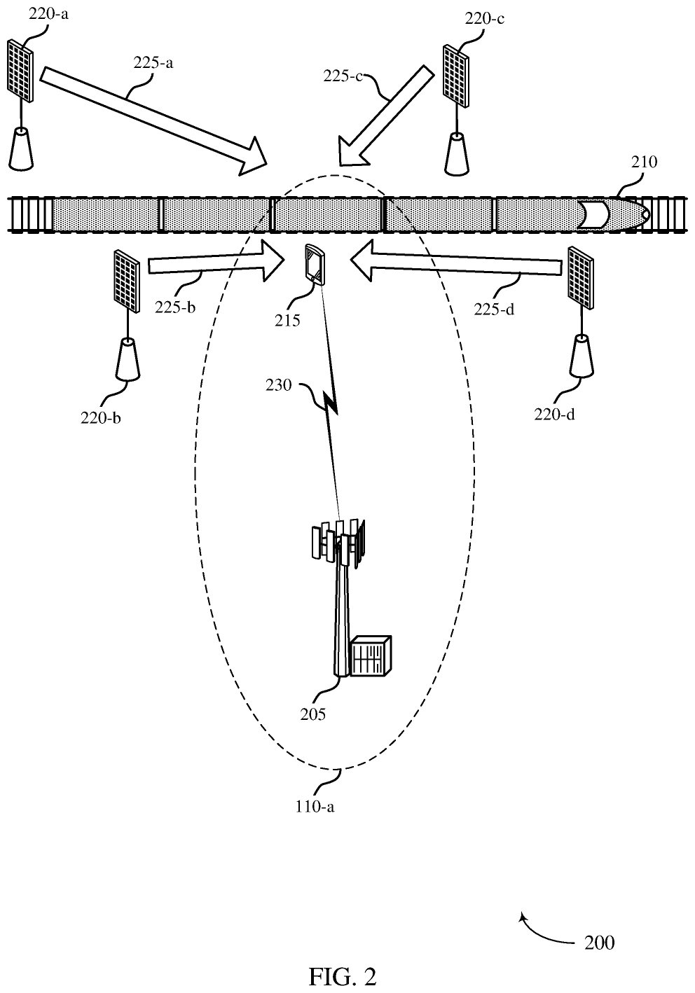

FIG. 2 illustrates an example of a wireless communications system 200 that supports techniques for transmission configuration indicator state switching for handover procedures in accordance with various aspects of the present disclosure. In some examples, wireless communications system 200 may include a UE 215, base station 205, network devices 220, or the like, which may be examples of corresponding devices described with reference to FIG. 1. For instance, network devices 220 may be base stations 105, access network transmission entities 145, repeaters, transmit receive points (TRPs), remote radio heads (RRHs), access points (APs), or any combination thereof. Each network device 220 may be managed, controlled, or otherwise signaled by another network device (e.g., a controller or base station).

In some examples, a wireless communications system 200 may support multiple communications systems or sub-systems. For instance, wireless communications system 200 may support a first communications system (e.g., an NSA system) and a second communications system (e.g., an SA system). In some examples, the first communications system may include an HST deployment for HST 210. The first communications system may include one or more network devices 220. For instance, network devices 220 may be repeaters deployed along the track for HST 210. Network devices 220 may generate or forward signaling for a UE 215 that is on board HST 210 (e.g., a UE 215 carried by a passenger, a UE affixed to or co-located with HST 210, or the like).

In some examples, the first communications system may support transmission of one or two synchronization signal blocks (SSBs). For instance, each network device 220 may transmit the same one or two SSBs (e.g., SSB 0 and SSB 1) using wide or coarse beams. Each cell of the first communications system may support a number of network devices (e.g., six network devices 220 including network device 220-a, network device 220-b, network device 220-c, and network device 220-d). In some examples, each network device 220 may transmit one or more reference signals according to different TCI states. For instance, each network device 220 may transmit a TRS 225 according to a different TCI state. In such examples, network device 220-a may transmit TRS 225-a according to a first TCI state, network device 220-b may transmit TRS 225-b according to a second TCI state, network device 220-c may transmit TRS 225-c according to a third TCI state, and network device 220-d may transmit TRS 225-d according to a fourth TCI state.

UE 215 may rely on the TRSs for subsequent receiving and decoding of control or data channels. In some examples, the TRSs 225 may not have a QCL relationship to the universal or repeated SSBs transmitted by all network devices 220 in a cell of the first communications system. However, the TRSs may have a QCL relationship with a physical downlink control channel (PDCCH), a physical downlink shared channel (PDSCH), or the like. Thus, by identifying and receiving the TRS, UE 215 may successfully and efficiently receive and decode control signaling on the PDCCH, data signaling on the PDSCH, or both.

Because each network device 220 transmits a separate TRS according to a different TCI state, UE 215 may update its TCI state as it travels along the track for HST 210. That is, as UE 215 travels along the track for HST 210, communication quality with, for instance, network device 220-a may degrade, and UE 215 may instead communicate with network device 220-b. Transitioning communications from network device 220-a to network device 220-b may be possible if UE 215 updates its TCI state for receiving signaling (e.g., TRS 225-bfrom network device 220-b. The network may update its TCI state as UE 215 travels along the HST track. Network devices 220 may determine a correct TCI state for transmitting TRSs based on uplink signals (e.g., sounding reference signals (SRSs)) received from UE 215. In some examples, network devices 220 may not rely on SSB index reports for updating TCI states. Network devices 220 may transmit control messages (e.g., MAC-CEs) with explicit indications of updated or activated TCI states. Thus, network devices 220 may explicitly signal a TCI state to UE 215, and may expect UE 215 to update its TCI state for receiving one or more subsequent TRSs 225. Thus, the network (e.g., via one or more network devices 220) may indicate, to UE 215, that it should use a first TCI state to receive TRS 225-a, a second TCI state to receive TRS 225-b, a third TCI state to receive TRS 225-c, and a fourth TCI state to receive TRS 225-d.

Having received an indication from the network (e.g., via one or more MAC-CEs) of which TCI states to use, UE 215 may successfully receive one or more TRSs 225. Based on a QCL relationship with PDSCHs or PDCCHs, based on information received in the TRSs (e.g., timing information, resource information, location information, tracking information, or any combination thereof), UE 215 may receive control signaling, data signaling, or both, from the network (e.g., via one or more network devices 220).

UE 215 may transition from the first communications system (e.g., the HST deployment) to the second communications system (e.g., an NSA 5G system). For instance, a user carrying UE 215 may disembark from the HST 210, or the HST 210 may stop, or service for the HST deployment may degrade, or the like. UE 215 may initiate a handover from the first communications system (e.g., from a first network device 220) to the second communications system (e.g., to base station 205 serving UEs 215 within coverage area 110-a). Such a handover may be considered (e.g., by the network) to be a same-cell handover. In such examples, UE 215 may establish a bidirectional communication link 230 with base station 205 (e.g., and may stop communicating with or monitoring for communications from one or more network devices 220 of the first communications system). In some examples, after such a transition, UE 215 may experience a higher block error (BLER) rate. For example, upon transitioning from an NSA system (e.g., the HST deployment) to an SA system, UE 215 may fail to successfully receive or process a TRS transmitted by base station 205. The network may consider such a handover to be a same-cell handover. However, in some examples, the second communications system (e.g., the SA system) may not support explicit TCI state indications via control signaling (e.g., MAC-CEs). For instance, UE 215 may monitor for an updated TCI state indication (e.g., via a MAC-CE) from base station 205. However, base station 205 may not support such signaling (e.g., may not transmit such MAC-CEs, or may not include TCI state indications in such MAC-CEs). In such examples, UE 215 may fail to determine which TCI state to use for monitoring for and receiving TRSs from base station 205. UE 215 may therefore fail to receive one or more subsequent TRSs from base station 205, and may fail to receive corresponding or subsequent data signals or control signals or both. If UE 215 were only configured with a single TCI state or a single active TCI state, then UE 215 could simply perform implicit down-selection (e.g., use the single TCI state) for receiving a subsequent TRS from base station 205. However, if UE 215 is configured with multiple TCI states or multiple active TCI states, then UE 215 may be unable to implicitly down-select a single TCI state.

Thus, if UE 215 transitions from the first communications system (e.g., the HST deployment) to the second communications system (e.g., the 5G system or SA system), UE 215 may rely on or expect to receive a MAC-CE indicating a TCI state for receiving subsequent TRSs. If base station 205 does not support transmission of such MAC-CEs, then UE 215 may not be able to determine which of multiple TCI states to use for receiving and processing a subsequent TRS from base station 205. In such examples, UE 215 may fail to receive one or more TRSs transmitted by base station 205, which may result in partial or complete failure to process subsequent control signaling, data signaling, or both.

UE 215 may configure a TCI state after initiating a handover based on determining whether one or more antenna port configuration conditions are satisfied. If such conditions are satisfied, then UE 215 may use a previously used (e.g., most recently used prior to the handover) TCI state for receiving TRSs after initiating the handover. For example, UE 215 may determine that a handover (e.g., a same-cell handover) has occurred or is occurring. In such examples, UE 215 may determine whether a first condition is satisfied. For instance, UE 215 may determine whether a QCL relationship exists or is configured between SSBs and TRSs. If no QCL relationship exists between SSBs and TRSs (e.g., UE 215 is or has been operating in the first communications system or is transitioning into the second communications system), then UE 215 may consider the first condition satisfied. UE 215 may determine whether a second condition is satisfied. For instance, UE 215 may determine whether implicit down-selection is available, or whether implicit down-selection has failed. If implicit down-selection fails or is unavailable (e.g., if UE 215 is configured with multiple TCI states and therefore cannot merely continue to use a single configured TCI state), then UE 215 may consider the second condition satisfied. UE 215 may determine whether it will receive a TCI state indication in a control message (e.g., a MAC-CE) after initiating the handover. For instance, UE 215 may monitor for a MAC-CE carrying an explicit indication of an updated TCI state from base station 205 via bidirectional communication link 230 after initiating the handover. If UE 215 does not receive such a MAC-CE, or if UE 215 receives a MAC-CE but determines that the received MAC-CE does not include such an indication of an updated TCI state, then UE 215 may consider the third condition satisfied. In some examples, UE 215 may proceed to use a previously utilized TCI state for receiving TRSs if all three conditions are satisfied. In some examples, UE 215 may proceed to use a previously utilized TCI state if one or more of the conditions, or other conditions, are satisfied. If all three conditions are satisfied, UE 215 may proceed as described herein.

If UE 215 determines that the conditions are satisfied, UE 215 may select a previously utilized TCI state for receiving subsequent TRSs. For instance, UE 215 may be configured with a number of TCI states (e.g., six TCI states for a cell in the first communications system). UE 215 may travel along the track for HST 210 and may receive TRS 225-a using a first TCI state, then TRS 225-b using a second TCI state, then TRS 225-c using a third TCI state. However, prior to receiving TRS 225-d using a fourth TCI state, UE 215 may initiate the handover to base station 205. If UE 215 determines that one or more of the conditions are satisfied (e.g., all of the conditions are satisfied), then UE 215 may use the most recently used TCI state prior to the handover (e.g., the third TCI state) to receive a next TRS from base station 205. UE 215 may then successfully receive and process downlink control signaling, downlink data signaling, or both (e.g., using the third TCI state or based on the received TRS, or both).

Techniques described herein may improve UE performance after a handover. However, such techniques may only be deployed if all conditions are satisfied, which may result in efficiently deploying the described techniques when useful (e.g., for an NSA to SA handover), without inefficiently deploying the described methods in all cases. For example, if a handover is accompanied by a TCI indication from a MAC-CE, then the UE may not have use for the described techniques because the handover would not result in a degradation of service of increased BLER. However, in such examples, at least one of the conditions would not be satisfied, and the UE 215 could refrain from implementing the described techniques.

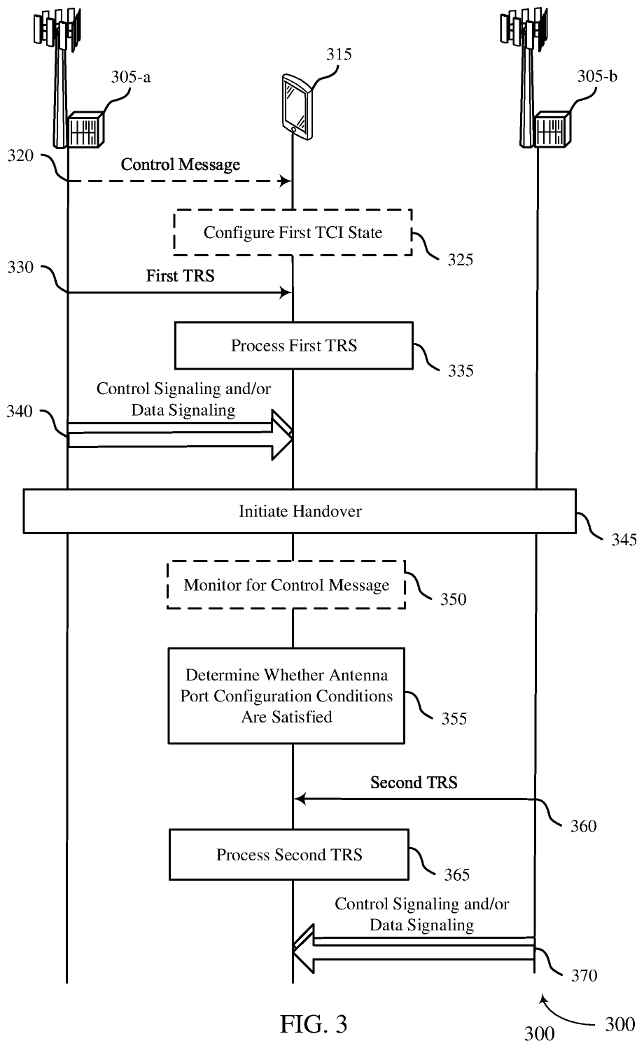

Techniques described herein may improve UE performance post-handover. Such handovers may be used for a handover from an NSA system to an SA system, an SA system to an NSA system, an HST deployment to a conventional 4G system or 5G system, a same-cell handover, or any other handover performed by a UE. UE 215 may determine whether conditions are satisfied and may select a TCI state based thereon after such handovers, as described in greater detail with reference to FIG. 3.

FIG. 3 illustrates an example of a process flow 300 that supports techniques for transmission configuration indicator state switching for handover procedures in accordance with various aspects of the present disclosure. Process flow 300 may include one or more UEs 315 which may be examples of UE 115 or UE 215 as described with reference to FIGS. 1 and 2, respectively. Process flow 300 may include one or more wireless network devices (e.g., base stations 305) which may be examples of base station 105, base station 205, network device 220, or the like, as described with reference to FIGS. 1 and 2.

In some examples, base stations 305 may correspond to different communications systems. For instance, base station 305a may correspond to the first wireless system (e.g., a network device such as a repeater, RRH, TRP, or the like, in a NSA deployment) whereas base station 305b may correspond to the second communications system (e.g., a base station 105 in an SA 4G or 5G deployment). Additionally, or alternatively, the base station 305-a or base station 305-b, or both, may be an example of a base station, an IAB node, a repeater node (e.g., configured with some retransmission capability), or the like. In some examples, an NSA system may employ the use of 4G core networks for the deployment of 5G communications where an SA system may employ the use of only 5G core networks and devices for 5G deployments. Formatting control information, reference signals, data transmissions, or the like, may vary from communication system to communication system. For instance, a base station 305-b operating in an NSA system may indicate control information in a first location within a control message, whereas an SA system may indicate the same control information in a different control message, or may not indicate the same control information at all. Likewise, base station 305-a may format outgoing control information and reference signals based on formatting specific to the first communication system. In some examples, base station 305-a and base station 305-b may be separate entities, located in different physical spaces. However, in some examples, base station 305-a and base station 305-b may be co-located, or may be the same network entity operating in the role of a first base station (e.g., as part of a first communications system) and subsequently acting in the role of a second base station (e.g., as part of a second communications system).

At 320, base station 305a may transmit a control message to UE 315. In some cases, the control message may be a MAC-CE, which may include an explicit indication of one or more TCI states. UE 315 may receive the control message indicating the one or more TCI states. UE 315 may use the TCI states to identify and process one or more subsequent TRSs. If base station 305-a does not transmit the control message to UE 315, UE may not be able to process TRSs, potentially resulting in an increased BLER, a dropped connection between UE 315 and base station 305-a, or the like.

At 325, having received the control message indicating the one or more first TCI state at 320, UE 315 may identify a first TCI state as indicated in the control message. UE 315 may be configured with multiple TCI states. Upon identifying the first TCI state of the multiple TCI states, UE 315 may configure itself according to the first TCI state. For example, UE 315 may configure one or more antennas and one or more antenna ports according to the first TCI state. Configuring UE 315 according to the first TCI state may allow UE to process subsequent TRSs transmitted by base station 305-a or another base station in the first communications system, according to the first TCI.

At 330, base station 305-a (or another base station 305 of the first communications system) may transmit a first TRS. UE 315 may receive the first TRS using the indicated first TCI state (e.g., according to the configuration of the antennas and antenna ports based on the indication of the first TCI state). UE 315 may use the received TRS for time and frequency tracking of subsequent control signaling, data signaling, or a combination thereof.

At 335, UE 315 may process the received first TRS based on the first TCI state. UE 315 may determine that the first TRS is QCLed with a PDCCH, a PDSCH, or a both. Upon processing the first TRS and determining the QCL relationship, UE 315 may configure itself to receive control signaling or data signaling from base station 305-a (or additional base stations 305 of the first communications system) based on information received in the first TRS.

At 340, the network device may transmit control signaling, data signaling, or a combination of both, to UE 315. In some cases, the PDCCH or PDSCH may be QCLed to the first TRS. UE 315 may receive the data or control signaling based on having successfully processed the TRS, and may thus maintain a connection with the network via base station 305-a.

At 345, UE 315 may initiate a handover. For example, UE 315 may discontinue a connection with base station 305-a and UE 315 may establish a connection with base station 305-b. In some examples, initiating the handover may be based on UE 315 changing locations (e.g., from one coverage area to another, from one region of a first coverage area to a second region of a first coverage area, or the like). For example, a UE 315 on an HST may be located in a coverage area corresponding to that of a first network device which supports an NSA communication system. The HST may come to a stop and UE 315 may be located in coverage areas corresponding to that of the first network device and a second network device where the second network device supports an SA communication system (e.g., the user of the UE 315 may disembark the HST). Additionally, or alternatively, the handover may be initiated due to one or more of a signal from base station 305-a or 305-b, autonomous determination at UE 315, the satisfaction of a threshold value, or the like.

In some examples, base station 305-b may not support the transmission of control messages including indications of TCI states. If UE 315 is unable to determine a TCI state for receiving subsequent TRSs, UE 315 may not be able to identify and process the subsequent TRSs, resulting in an increased BLER, decreased signal throughput, a dropped network connection, or the like. To mitigate such issues, UE 315 may implement techniques described herein at 355 and 360.

At 350, after the handover, UE 315 may monitor for a control message from base station 305-b. In some cases, base station 305-b may operate according to the second communication system, which may be an example of an SA system. The second communications system may not support transmission of control signals including an explicit indication of a TCI state (e.g., for receiving TRSs). UE 315 may monitor for such a control message (e.g., a MAC CE) from base station 305-b. However, base station 305-b may not transmit such a control message to UE 315. Additionally, or alternatively, the network device may transmit a control message to UE 315, but the control message may not include an indication of one or more TCI states. In some cases, if UE 315 does not identify a TCI state to use for receiving TRSs or subsequent signaling, UE 315 may not be able to identify and process subsequent TRSs, resulting in an increased BLER, connection loss, or the like. So, UE 315 may autonomously determine a TCI state configuration based on the status of one or more antenna port configuration conditions.

At 355, UE 315 may determine whether one or more antenna port configuration conditions are satisfied. UE 315 may determine that a first antenna port configuration condition is satisfied by monitoring for a MAC CE indicating a TCI state. If UE 315 fails to receive the control message, then UE 315 may determine that the first antenna port configuration condition is satisfied. In some examples, UE 315 may determine that a second antenna port configuration condition is satisfied by determining that implicit down-selection of TCI fails. For example, if UE 315 determines that multiple TCI states are configured (e.g., implicit down-selection of TCI fails), and UE 315 cannot continue to use a single configured TCI state, then UE 315 may determine that the second antenna port configuration condition is satisfied. In some examples, UE 315 may determine that a third antenna port configuration condition is satisfied by verifying the existence of or lack of one or more QCL relationships. For example, if UE 315 may determine that there is not a QCL relationship between one or more synchronization signals (e.g., SSBs) and a TRS, then UE 315 may determine that the third antenna port configuration condition is satisfied. If UE 315 determines that one or more (e.g., all) of the antenna port configuration conditions are satisfied, UE 315 may use the most recently indicated TCI state prior to the handover. That is, UE 315 may use the most recently used TCI state (e.g., the TCI state indicated at 320 prior to initiating the handover) to receive a next TRS from base station 305b at 360. In some examples, if UE 315 has reconfigured its TCI state after imitating the handover at 345, UE 315 may reconfigure one or more antennas or antenna ports or both according to the first TCI state based on having determined that all of the antenna port configuration conditions are satisfied.

At 360, base station 305-b may transmit a second TRS. UE 315 may receive and process the second TRS using the most recently used TCI state (e.g., the TCI state indicated at 320). UE 315 may not reconfigure its antenna ports (e.g., may continue to monitor and receive signaling using the previously indicated TCI state) based on determining that one or more (e.g., all) of the antenna port configuration conditions are satisfied at 355.

At 365, UE 315 may process the second TRS based on the TCI state indicated at 320 (prior to the handover). Upon processing the second TRS, UE may identify a QCL relationship between the second TRS and one or more of a PDCCH and a PDSCH. UE 315 receive control signaling, data signaling, or both, based on having processed the second TRS using the previously used TCI state.

At 370, UE 315 may receive one or more of control signaling and data signaling based on having received the second TRS from base station 305-b. Receiving the control signaling, data signaling, or both may allow UE 315 to continue communication with the network via base station 305-b without experiencing an increased in BLER.

In the preceding description of the process flow 300, the operations performed by UE 315, base station 305-a, and base station 305-b may be performed in different orders or at different times. Additionally, or alternatively, some operations performed by UE 315, base station 305-a, and base station 305-b may be performed contemporaneously. Some operations may also be left out of the process flow 300, or other operations may be added to the process flow 300. It is to be understood that while UE 315, base station 305-a, and base station 305-b are shown performing a number of the operations of process flow 300, any wireless device may perform the operations shown.

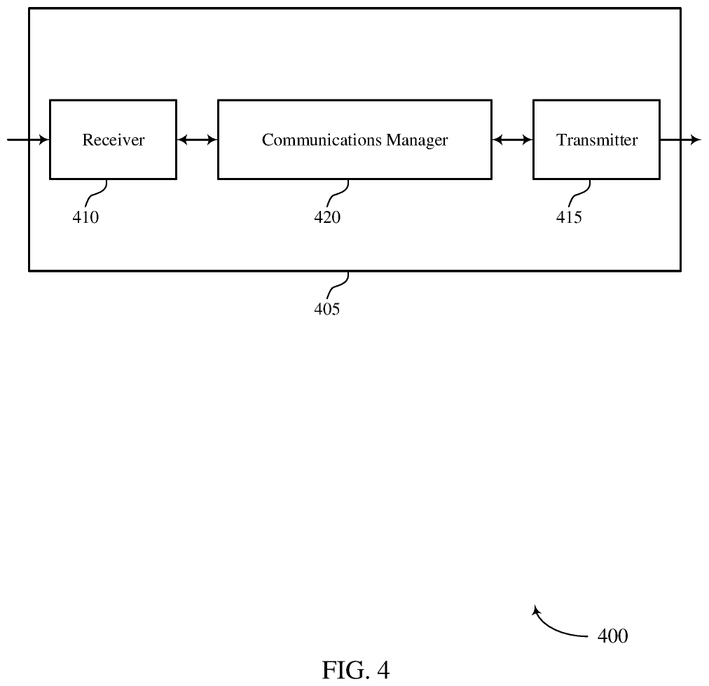

FIG. 4 shows a block diagram 400 of a device 405 that supports techniques for transmission configuration indicator state switching for handover procedures in accordance with aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for transmission configuration indicator state switching for handover procedures). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for transmission configuration indicator state switching for handover procedures). In some examples, the transmitter 415 may be co-located with a receiver 410 in a transceiver component. The transmitter 415 may utilize a single antenna or a set of multiple antennas.

The communications manager 420, the receiver 410, the transmitter 415, or various combinations thereof or various components thereof may be examples of means for performing various aspects of techniques for transmission configuration indicator state switching for handover procedures as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

The communications manager 420 may support wireless communications at a UE in accordance with examples as disclosed herein. For example, the communications manager 420 may be configured as or otherwise support a means for receiving, from a first network device in a first cell, a first tracking reference signal using a first transmission configuration indicator state of a set of transmission configuration indicator states. The communications manager 420 may be configured as or otherwise support a means for initiating a handover from the first network device to a second network device. The communications manager 420 may be configured as or otherwise support a means for receiving, from the second network device, a second tracking reference signal using the first transmission configuration indicator state, where using the first transmission configuration indicator state is based on one or more antenna port configuration conditions being satisfied.

By including or configuring the communications manager 420 in accordance with examples as described herein, the device 405 (e.g., a processor controlling or otherwise coupled to the receiver 410, the transmitter 415, the communications manager 420, or a combination thereof) may support techniques for handover procedures resulting in decreased BLER, decreased likelihood of failed connections, improved communications, improved system efficiency, and improved user experience.

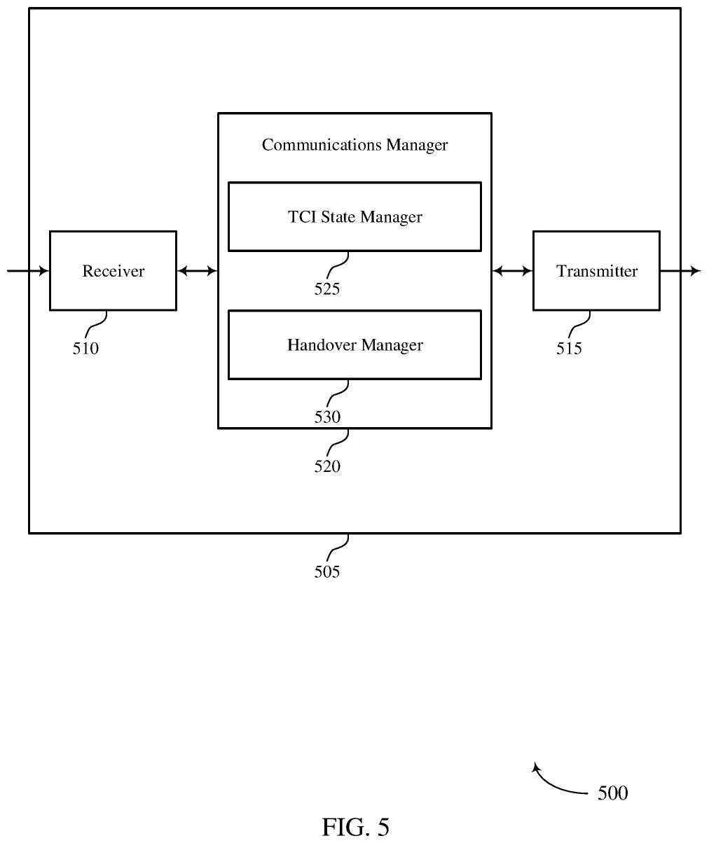

FIG. 5 shows a block diagram 500 of a device 505 that supports techniques for transmission configuration indicator state switching for handover procedures in accordance with aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for transmission configuration indicator state switching for handover procedures). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for transmission configuration indicator state switching for handover procedures). In some examples, the transmitter 515 may be co-located with a receiver 510 in a transceiver component. The transmitter 515 may utilize a single antenna or a set of multiple antennas.

The device 505, or various components thereof, may be an example of means for performing various aspects of techniques for transmission configuration indicator state switching for handover procedures as described herein. For example, the communications manager 520 may include a TCI state manager 525 a handover manager 530, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a UE in accordance with examples as disclosed herein. The TCI state manager 525 may be configured as or otherwise support a means for receiving, from a first network device in a first cell, a first tracking reference signal using a first transmission configuration indicator state of a set of transmission configuration indicator states. The handover manager 530 may be configured as or otherwise support a means for initiating a handover from the first network device to a second network device. The TCI state manager 525 may be configured as or otherwise support a means for receiving, from the second network device, a second tracking reference signal using the first transmission configuration indicator state, where using the first transmission configuration indicator state is based on one or more antenna port configuration conditions being satisfied.

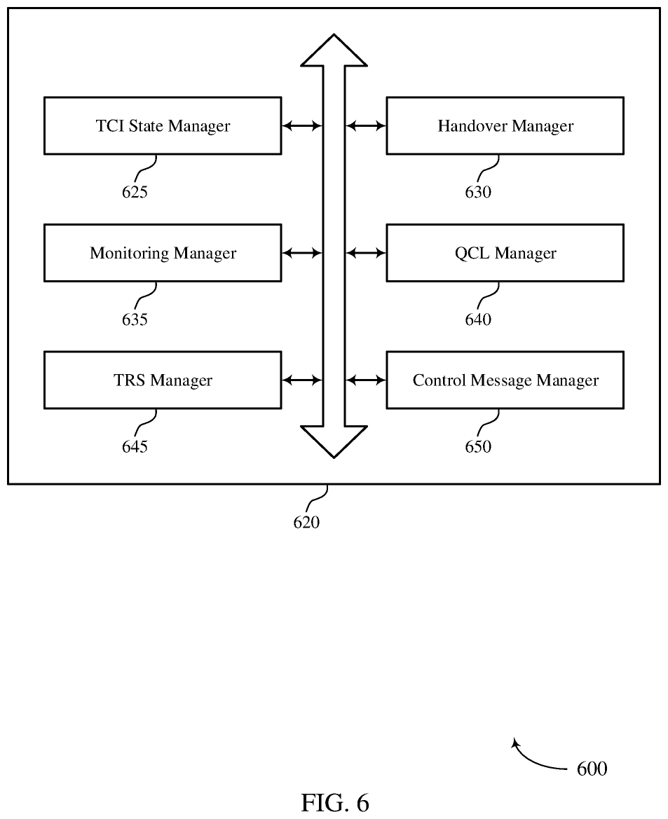

FIG. 6 shows a block diagram 600 of a communications manager 620 that supports techniques for transmission configuration indicator state switching for handover procedures in accordance with aspects of the present disclosure. The communications manager 620 may be an example of aspects of a communications manager 420, a communications manager 520, or both, as described herein. The communications manager 620, or various components thereof, may be an example of means for performing various aspects of techniques for transmission configuration indicator state switching for handover procedures as described herein. For example, the communications manager 620 may include a TCI state manager 625, a handover manager 630, a monitoring manager 635, a QCL manager 640, an TRS manager 645, a control message manager 650, or any combination thereof. Each of these components may communicate, directly or indirectly, with one another (e.g., via one or more buses).

The communications manager 620 may support wireless communications at a UE in accordance with examples as disclosed herein. The TCI state manager 625 may be configured as or otherwise support a means for receiving, from a first network device in a first cell, a first tracking reference signal using a first transmission configuration indicator state of a set of transmission configuration indicator states. The handover manager 630 may be configured as or otherwise support a means for initiating a handover from the first network device to a second network device. In some examples, the TCI state manager 625 may be configured as or otherwise support a means for receiving, from the second network device, a second tracking reference signal using the first transmission configuration indicator state, where using the first transmission configuration indicator state is based on one or more antenna port configuration conditions being satisfied.

In some examples, the monitoring manager 635 may be configured as or otherwise support a means for monitoring, after initiating the handover, for a control message including an indication of a second transmission configuration indicator state. In some examples, the monitoring manager 635 may be configured as or otherwise support a means for failing to receive the control message based on the monitoring.

In some examples, the TCI state manager 625 may be configured as or otherwise support a means for determining that the first transmission configuration indicator state is one of the set of transmission configuration indicator states, wherein the set of transmission configuration indicator states comprises a plurality of transmission configuration indicator states.

In some examples, the QCL manager 640 may be configured as or otherwise support a means for determining that a quasi-co-location relationship does not exist between one or more synchronization signals and at least one of the first tracking reference signal or the second tracking reference signal.

In some examples, the TRS manager 645 may be configured as or otherwise support a means for processing the second tracking reference signal using the first transmission configuration indicator state. In some examples, the TRS manager 645 may be configured as or otherwise support a means for receiving control signaling, data signaling, or both, based on the processed tracking reference signal.

In some examples, to support initiating the handover, the handover manager 630 may be configured as or otherwise support a means for initiating a same-cell handover.

In some examples, to support initiating the handover, the handover manager 630 may be configured as or otherwise support a means for initiating a handover from a non-standalone system to a stand-alone system.

In some examples, the first network device includes a base station, a repeater, a radio head, or any combination thereof, associated with a high speed train network deployment.

In some examples, the control message manager 650 may be configured as or otherwise support a means for receiving, from the first network device prior to initiating the handover, a control message including an indication of the first transmission configuration indicator state, where receiving the first tracking reference signal using the first transmission configuration indicator state is based on receiving the control message.

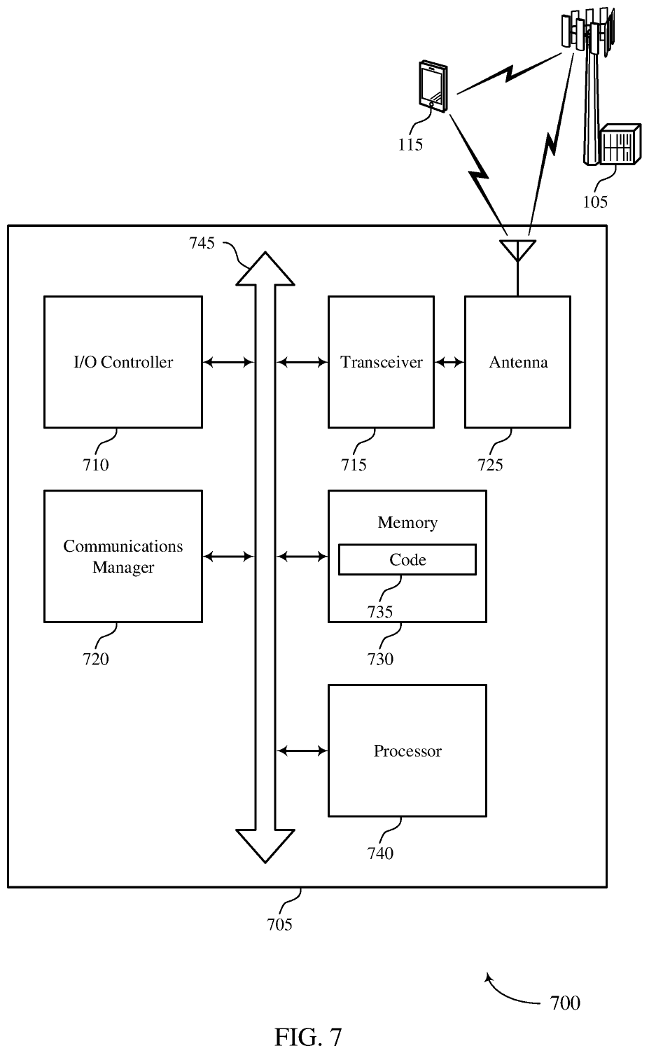

FIG. 7 shows a diagram of a system 700 including a device 705 that supports techniques for transmission configuration indicator state switching for handover procedures in accordance with aspects of the present disclosure. The device 705 may be an example of or include the components of a device 405, a device 505, or a UE 115 as described herein. The device 705 may communicate wirelessly with one or more base stations 105, UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/0 controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting techniques for transmission configuration indicator state switching for handover procedures). For example, the device 705 or a component of the device 705 may include a processor 740 and memory 730 coupled to the processor 740, the processor 740 and memory 730 configured to perform various functions described herein.

The communications manager 720 may support wireless communications at a UE in accordance with examples as disclosed herein. For example, the communications manager 720 may be configured as or otherwise support a means for receiving, from a first network device in a first cell, a first tracking reference signal using a first transmission configuration indicator state of a set of transmission configuration indicator states. The communications manager 720 may be configured as or otherwise support a means for initiating a handover from the first network device to a second network device. The communications manager 720 may be configured as or otherwise support a means for receiving, from the second network device, a second tracking reference signal using the first transmission configuration indicator state, where using the first transmission configuration indicator state is based on one or more antenna port configuration conditions being satisfied.

By including or configuring the communications manager 720 in accordance with examples as described herein, the device 705 may support techniques for handover procedures resulting in decreased BLER, decreased likelihood of failed connections, improved communications, improved system efficiency, and improved user experience.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of techniques for transmission configuration indicator state switching for handover procedures as described herein, or the processor 740 and the memory 730 may be otherwise configured to perform or support such operations.

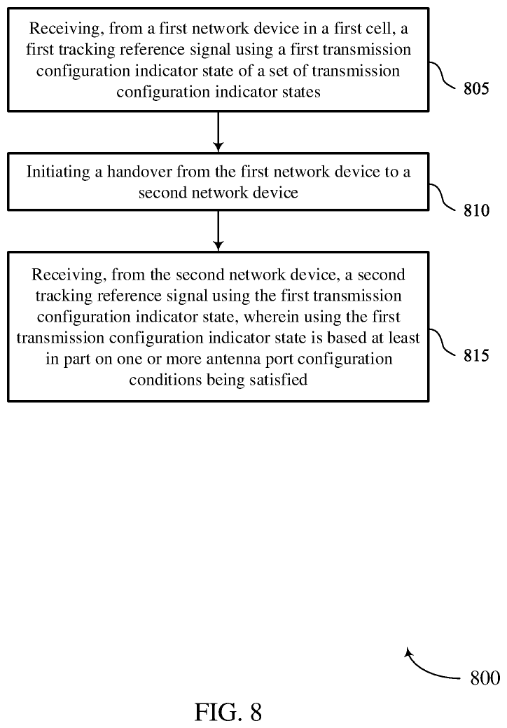

FIG. 8 shows a flowchart illustrating a method 800 that supports techniques for transmission configuration indicator state switching for handover procedures in accordance with aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving, from a first network device in a first cell, a first tracking reference signal using a first transmission configuration indicator state of a set of transmission configuration indicator states. The operations of 805 may be performed in accordance with examples as disclosed herein. In some examples, aspects of the operations of 805 may be performed by a TCI state manager 625 as described with reference to FIG. 6.

At 810, the method may include initiating a handover from the first network device to a second network device. The operations of 810 may be performed in accordance with examples as disclosed herein. In some examples, aspects of the operations of 810 may be performed by a handover manager 630 as described with reference to FIG. 6.

At 815, the method may include receiving, from the second network device, a second tracking reference signal using the first transmission configuration indicator state, where using the first transmission configuration indicator state is based on one or more antenna port configuration conditions being satisfied. The operations of 815 may be performed in accordance with examples as disclosed herein. In some examples, aspects of the operations of 815 may be performed by a TCI state manager 625 as described with reference to FIG. 6.

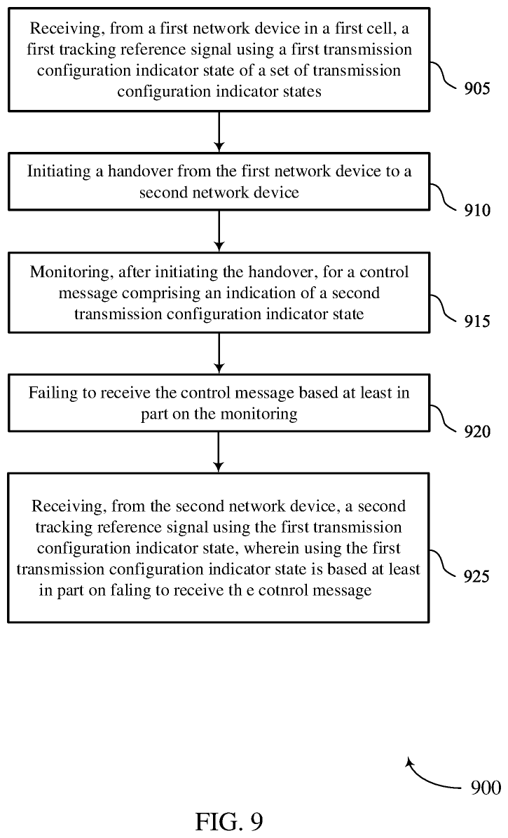

FIG. 9 shows a flowchart illustrating a method 900 that supports techniques for transmission configuration indicator state switching for handover procedures in accordance with aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include receiving, from a first network device in a first cell, a first tracking reference signal using a first transmission configuration indicator state of a set of transmission configuration indicator states. The operations of 905 may be performed in accordance with examples as disclosed herein. In some examples, aspects of the operations of 905 may be performed by a TCI state manager 625 as described with reference to FIG. 6.

At 910, the method may include initiating a handover from the first network device to a second network device. The operations of 910 may be performed in accordance with examples as disclosed herein. In some examples, aspects of the operations of 910 may be performed by a handover manager 630 as described with reference to FIG. 6.

At 915, the method may include monitoring, after initiating the handover, for a control message including an indication of a second transmission configuration indicator state. The operations of 915 may be performed in accordance with examples as disclosed herein. In some examples, aspects of the operations of 915 may be performed by a monitoring manager 635 as described with reference to FIG. 6.

At 920, the method may include failing to receive the control message based on the monitoring. The operations of 920 may be performed in accordance with examples as disclosed herein. In some examples, aspects of the operations of 920 may be performed by a monitoring manager 635 as described with reference to FIG. 6.

At 925, the method may include receiving, from the second network device, a second tracking reference signal using the first transmission configuration indicator state, where using the first transmission configuration indicator state is based on failing to receive the control message. The operations of 925 may be performed in accordance with examples as disclosed herein. In some examples, aspects of the operations of 925 may be performed by a TCI state manager 625 as described with reference to FIG. 6.

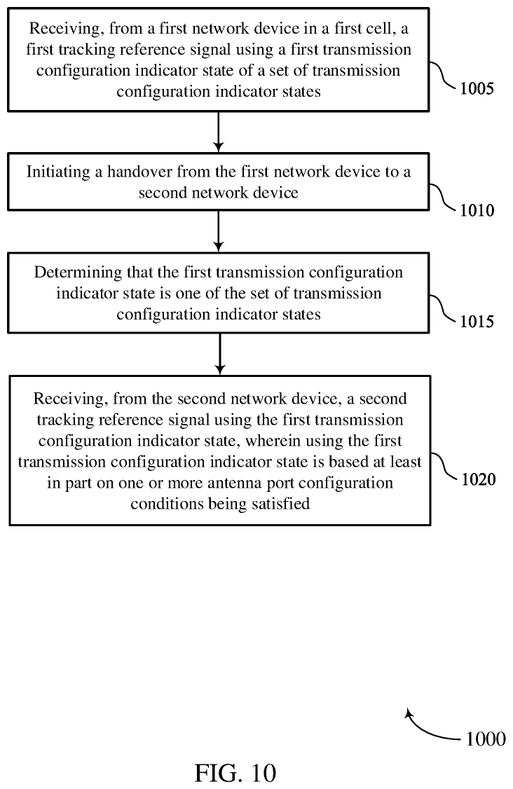

FIG. 10 shows a flowchart illustrating a method 1000 that supports techniques for transmission configuration indicator state switching for handover procedures in accordance with aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include receiving, from a first network device in a first cell, a first tracking reference signal using a first transmission configuration indicator state of a set of transmission configuration indicator states. The operations of 1005 may be performed in accordance with examples as disclosed herein. In some examples, aspects of the operations of 1005 may be performed by a TCI state manager 625 as described with reference to FIG. 6.

At 1010, the method may include initiating a handover from the first network device to a second network device. The operations of 1010 may be performed in accordance with examples as disclosed herein. In some examples, aspects of the operations of 1010 may be performed by a handover manager 630 as described with reference to FIG. 6.

At 1015, the method may include determining that the first transmission configuration indicator state is one of the set of transmission configuration indicator states, wherein the set of transmission configuration indicator states comprises a plurality of transmission configuration indicator states. The operations of 1015 may be performed in accordance with examples as disclosed herein. In some examples, aspects of the operations of 1015 may be performed by a TCI state manager 625 as described with reference to FIG. 6.

At 1020, the method may include receiving, from the second network device, a second tracking reference signal using the first transmission configuration indicator state, where using the first transmission configuration indicator state is based on determining that the first transmission configuration indicator state is one of the set of transmission configuration indicator states. The operations of 1020 may be performed in accordance with examples as disclosed herein. In some examples, aspects of the operations of 1020 may be performed by a TCI state manager 625 as described with reference to FIG. 6.

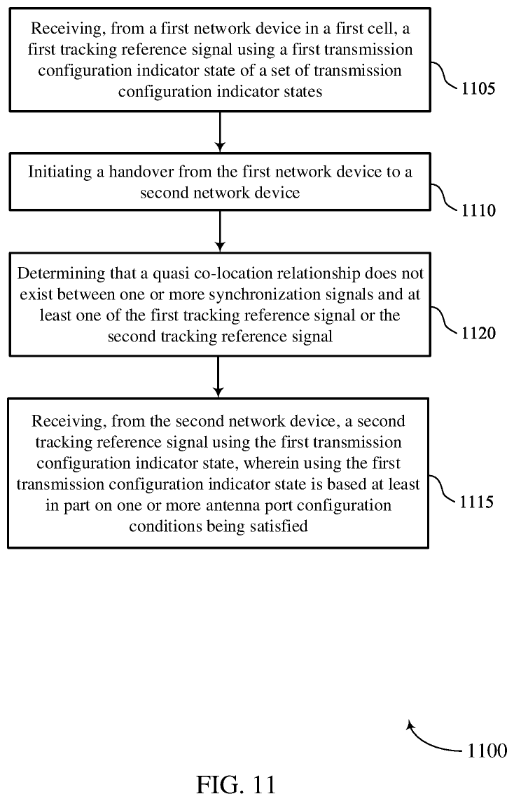

FIG. 11 shows a flowchart illustrating a method 1100 that supports techniques for transmission configuration indicator state switching for handover procedures in accordance with aspects of the present disclosure. The operations of the method 1100 may be implemented by a UE or its components as described herein. For example, the operations of the method 1100 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1105, the method may include receiving, from a first network device in a first cell, a first tracking reference signal using a first transmission configuration indicator state of a set of transmission configuration indicator states. The operations of 1105 may be performed in accordance with examples as disclosed herein. In some examples, aspects of the operations of 1105 may be performed by a TCI state manager 625 as described with reference to FIG. 6.

At 1110, the method may include initiating a handover from the first network device to a second network device. The operations of 1110 may be performed in accordance with examples as disclosed herein. In some examples, aspects of the operations of 1110 may be performed by a handover manager 630 as described with reference to FIG. 6.

At 1115, the method may include determining that a quasi-co-location relationship does not exist between one or more synchronization signals and at least one of the first tracking reference signal or the second tracking reference signal. The operations of 1115 may be performed in accordance with examples as disclosed herein. In some examples, aspects of the operations of 1115 may be performed by a QCL manager 640 as described with reference to FIG. 6.

At 1120, the method may include receiving, from the second network device, a second tracking reference signal using the first transmission configuration indicator state, where using the first transmission configuration indicator state is based on determining that the quasi co-location relationship does not exist between one or more synchronization signals and at least one of the first tracking reference signal or the second tracking reference signal. The operations of 1120 may be performed in accordance with examples as disclosed herein. In some examples, aspects of the operations of 1120 may be performed by a TCI state manager 625 as described with reference to FIG. 6.

Aspect 1: A method for wireless communications at a UE, comprising: receiving, from a first network device in a first cell, a first tracking reference signal using a first transmission configuration indicator state of a set of transmission configuration indicator states; initiating a handover from the first network device to a second network device; and receiving, from the second network device, a second tracking reference signal using the first transmission configuration indicator state, wherein using the first transmission configuration indicator state is based at least in part on one or more antenna port configuration conditions being satisfied.

Aspect 2: The method of aspect 1, further comprising: monitoring, after initiating the handover, for a control message comprising an indication of a second transmission configuration indicator state; and failing to receive the control message based at least in part on the monitoring.

Aspect 3: The method of any of aspects 1 through 2, further comprising: determining that the first transmission configuration indicator state is one of the set of transmission configuration indicator states.

Aspect 4: The method of any of aspects 1 through 3, further comprising: determining that a quasi co-location relationship does not exist between one or more synchronization signals and at least one of the first tracking reference signal or the second tracking reference signal.

Aspect 5: The method of any of aspects 1 through 4, further comprising: processing the second tracking reference signal using the first transmission configuration indicator state; and receiving control signaling, data signaling, or both, based at least in part on the processed tracking reference signal.

Aspect 6: The method of any of aspects 1 through 5, wherein initiating the handover comprises: initiating a same-cell handover.

Aspect 7: The method of any of aspects 1 through 6, wherein initiating the handover comprises: initiating a handover from a non-standalone system to a stand-alone system.

Aspect 8: The method of any of aspects 1 through 7, wherein the first network device comprises a base station, a repeater, a radio head, or any combination thereof, associated with a high speed train network deployment.

Aspect 9: The method of any of aspects 1 through 8, further comprising: receiving, from the first network device prior to initiating the handover, a control message comprising an indication of the first transmission configuration indicator state, wherein receiving the first tracking reference signal using the first transmission configuration indicator state is based at least in part on receiving the control message

Aspect 10: An apparatus for wireless communications at a UE, comprising a processor; memory coupled with the processor; and instructions stored in the memory and executable by the processor to cause the apparatus to perform a method of any of aspects 1 through 9.

Aspect 11: An apparatus for wireless communications at a UE, comprising at least one means for performing a method of any of aspects 1 through 9.

Aspect 12: A non-transitory computer-readable medium storing code for wireless communications at a UE, the code comprising instructions executable by a processor to perform a method of any of aspects 1 through 9.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving, from a first network device in a first cell, a first tracking reference signal using a first transmission configuration indicator state of a set of transmission configuration indicator states;
initiating a handover from the first network device to a second network device; and
receiving, from the second network device, a second tracking reference signal using the first transmission configuration indicator state, wherein using the first transmission configuration indicator state is based at least in part on one or more antenna port configuration conditions being satisfied.

2. The method of claim 1, further comprising:
monitoring, after initiating the handover, for a control message comprising an indication of a second transmission configuration indicator state; and
failing to receive the control message based at least in part on the monitoring.

3. The method of claim 1, further comprising:
determining that the first transmission configuration indicator state is one of the set of transmission configuration indicator states, wherein the set of transmission configuration indicator states comprises a plurality of transmission configuration indicator states.

4. The method of claim 1, further comprising:
determining that a quasi-co-location relationship does not exist between one or more synchronization signals and at least one of the first tracking reference signal or the second tracking reference signal.

5. The method of claim 1, further comprising:
processing the second tracking reference signal using the first transmission configuration indicator state; and
receiving control signaling, data signaling, or both, based at least in part on the processed tracking reference signal.

6. The method of claim 1, wherein initiating the handover comprises:
initiating a same-cell handover.

7. The method of claim 1, wherein initiating the handover comprises:
initiating a handover from a non-standalone system to a stand-alone system.

8. The method of claim 1, wherein the first network device comprises a base station, a repeater, a radio head, or any combination thereof, associated with a high speed train network deployment.

9. The method of claim 1, further comprising:
receiving, from the first network device prior to initiating the handover, a control message comprising an indication of the first transmission configuration indicator state, wherein receiving the first tracking reference signal using the first transmission configuration indicator state is based at least in part on receiving the control message

10. An apparatus for wireless communications at a user equipment (UE), comprising:
a processor;
memory coupled with the processor; and
instructions stored in the memory and executable by the processor to cause the apparatus to:
receive, from a first network device in a first cell, a first tracking reference signal using a first transmission configuration indicator state of a set of transmission configuration indicator states;
initiate a handover from the first network device to a second network device; and
receive, from the second network device, a second tracking reference signal using the first transmission configuration indicator state, wherein using the first transmission configuration indicator state is based at least in part on one or more antenna port configuration conditions being satisfied.

11. The apparatus of claim 10, wherein the instructions are further executable by the processor to cause the apparatus to:
monitor, after initiating the handover, for a control message comprising an indication of a second transmission configuration indicator state; and
fail to receive the control message based at least in part on the monitoring.

12. The apparatus of claim 10, wherein the instructions are further executable by the processor to cause the apparatus to:
determine that the first transmission configuration indicator state is one of the set of transmission configuration indicator states, wherein the set of transmission configuration indicator states comprises a plurality of transmission configuration indicator states.

13. The apparatus of claim 10, wherein the instructions are further executable by the processor to cause the apparatus to:
determine that a quasi-co-location relationship does not exist between one or more synchronization signals and at least one of the first tracking reference signal or the second tracking reference signal.

14. The apparatus of claim 10, wherein the instructions are further executable by the processor to cause the apparatus to:
process the second tracking reference signal using the first transmission configuration indicator state; and
receive control signaling, data signaling, or both, based at least in part on the processed tracking reference signal.

15. The apparatus of claim 10, wherein the instructions to initiate the handover are executable by the processor to cause the apparatus to:
initiate a same-cell handover.

16. The apparatus of claim 10, wherein the instructions to initiate the handover are executable by the processor to cause the apparatus to:
initiate a handover from a non-standalone system to a stand-alone system.

17. The apparatus of claim 10, wherein the first network device comprises a base station, a repeater, a radio head, or any combination thereof, associated with a high speed train network deployment.

18. The apparatus of claim 10, wherein the instructions are further executable by the processor to cause the apparatus to:
receive, from the first network device prior to initiating the handover, a control message comprising an indication of the first transmission configuration indicator state, wherein receiving the first tracking reference signal using the first transmission configuration indicator state is based at least in part on receiving the control message

19. An apparatus for wireless communications at a user equipment (UE), comprising:
means for receiving, from a first network device in a first cell, a first tracking reference signal using a first transmission configuration indicator state of a set of transmission configuration indicator states;
means for initiating a handover from the first network device to a second network device; and
means for receiving, from the second network device, a second tracking reference signal using the first transmission configuration indicator state, wherein using the first transmission configuration indicator state is based at least in part on one or more antenna port configuration conditions being satisfied.

20. The apparatus of claim 19, further comprising:
means for monitoring, after initiating the handover, for a control message comprising an indication of a second transmission configuration indicator state; and
means for failing to receive the control message based at least in part on the monitoring.

21. The apparatus of claim 19, further comprising:
means for determining that the first transmission configuration indicator state is one of the set of transmission configuration indicator states, wherein the set of transmission configuration indicator states comprises a plurality of transmission configuration indicator states.

22. The apparatus of claim 19, further comprising:
means for determining that a quasi-co-location relationship does not exist between one or more synchronization signals and at least one of the first tracking reference signal or the second tracking reference signal.

23. The apparatus of claim 19, further comprising:
means for processing the second tracking reference signal using the first transmission configuration indicator state; and
means for receiving control signaling, data signaling, or both, based at least in part on the processed tracking reference signal.

24. The apparatus of claim 19, wherein the means for initiating the handover comprise:
means for initiating a same-cell handover.

25. The apparatus of claim 19, wherein the means for initiating the handover comprise:
means for initiating a handover from a non-standalone system to a stand-alone system.

26. The apparatus of claim 19, further comprising:
means for receiving, from the first network device prior to initiating the handover, a control message comprising an indication of the first transmission configuration indicator state, wherein receiving the first tracking reference signal using the first transmission configuration indicator state is based at least in part on receiving the control message

27. A non-transitory computer-readable medium storing code for wireless communications at a user equipment (UE), the code comprising instructions executable by a processor to:
receive, from a first network device in a first cell, a first tracking reference signal using a first transmission configuration indicator state of a set of transmission configuration indicator states;
initiate a handover from the first network device to a second network device; and
receive, from the second network device, a second tracking reference signal using the first transmission configuration indicator state, wherein using the first transmission configuration indicator state is based at least in part on one or more antenna port configuration conditions being satisfied.

28. The non-transitory computer-readable medium of claim 27, wherein the instructions are further executable by the processor to:
monitor, after initiating the handover, for a control message comprising an indication of a second transmission configuration indicator state; and
fail to receive the control message based at least in part on the monitoring.

29. The non-transitory computer-readable medium of claim 27, wherein the instructions are further executable by the processor to:
determine that the first transmission configuration indicator state is one of the set of transmission configuration indicator states, wherein the set of transmission configuration indicator states comprises a plurality of transmission configuration indicator states.

30. The non-transitory computer-readable medium of claim 27, wherein the instructions are further executable by the processor to:
determine that a quasi-co-location relationship does not exist between one or more synchronization signals and at least one of the first tracking reference signal or the second tracking reference signal.
